(19) United States
(12) Patent Application Publication
(10) Pub. No.: US 2012/0272150 A1
(43) Pub. Date: Oct. 25, 2012

(54) SYSTEM AND METHOD FOR INTEGRATING VIDEO PLAYBACK AND NOTATION RECORDING

(76) Inventor: Benjamin Insler, New York, NY (US)

(21) Appl. No.: 13/454,075

(22) Filed: Apr. 23, 2012

Related U.S. Application Data
(60) Provisional application No. 61/477,911, filed on Apr. 21, 2011.

(51) Int. Cl. G06F 3/01

(52) U.S. Cl. 715/716

(57) ABSTRACT

A system and method for associating notations with multimedia elements is disclosed. In one example, the method comprises acts of displaying a multimedia element on a display of a computer device, receiving a notation element from a user of the computer device, determining, by a processor, at the time of receiving the notation element, a related portion of the multimedia element, and storing, on a storage medium, the notation element in association with a reference to the related portion of the multimedia event.

### RELATED APPLICATIONS

This application claims priority under 35 U.S.C. §119(e) to U.S. Provisional Application Ser. No. 61/477,911 entitled “SYSTEM AND METHOD FOR INTEGRATING VIDEO PLAYBACK AND NOTATION RECORDING,” filed on Apr. 21, 2011, which is hereby incorporated herein by reference in its entirety.

### BACKGROUND

1. Applicable Field

The present invention is in the field of multimedia presentation.

2. Related Art

Post production film editing is an important part in the process of filmmaking Typically, editing is performed in multiple stages, including a first or a rough cut and a final cut. One or more filmmakers may be involved in the editing process, making independent contributions to make the final product. The filmmakers involved in editing can include one or more film editors, assistant editors, picture editors or sound editors, as well as directors and/or producers.

### SUMMARY

While mobile technology has made working remotely more effective, the array of devices and connection options available to users is not always straightforward or convenient to use for every task. Filmmakers desiring to work remotely have to juggle the array of devices to view and edit film footage. For example, a director or producer working remotely may wish to view an editor's cut when it is ready, add notes and make comments, and forward the notes back to the editor to be incorporated into the footage. For filmmakers working remotely, making comments while viewing footage may necessitate constantly pausing video playback and switching between video playback software and a word processor.

Traditionally, to simultaneously display video footage on a handheld, mobile or computer device and also record specific notation, the individual or operator (e.g. the user) is needs to control playback of the footage using one interface while recording the personally authored notes and associated place in the video using a second interface separate from the first. In addition, the traditional playback interfaces available on various computer devices are not configured to be used for editing, providing playback control functions that are hard to use for editing purposes. Further, these discrete interfaces traditionally provide no exchange of information or capacity to communicate between each other.

Therefore, there is a need for a system and method that integrates video playback and notation recoding into one seamless application. The system and method described herein combine resources for multimedia playback of video and/or audio referred to herein as multimedia, contextual video and/or audio timing references multimedia (e.g. multimedia time code), and notation recording. The integrated system and method may be used in any field or area, including but not limited to the motion picture and television industry, video production industry, or any other area where a combination of such resources may prove to be useful on either a mobile device, desktop or laptop computer.

According to one embodiment, a method for associating notations with multimedia elements is disclosed. The method comprises acts of providing, a user interface to a user on a display of a computer device, the user interface including an input component configured to receive input from the user and a multimedia display component, displaying, by the multimedia display component, a multimedia element on the display of the computer device, receiving, by the input component, a notation element from the user of the computer device, determining, by a processor, at the time of receiving the notation element, a related portion of the multimedia element, and storing, on a storage medium, the notation element in association with a reference to the related portion of the multimedia event.

In some embodiments, the method further includes an act of responsive to receiving a control command from the user of the display device, changing a playback status of the multimedia element. In the method, the reference to the related portion of the multimedia event may comprise time code information.

In one embodiment, the method further includes the acts of receiving an input from one of: an external input device coupled to the computer device, and the display of the computer device, and determining, by the processor, the control command associated with the input. In the method, receiving the input from the display of the computer device may comprise receiving a gesture input by the user in the display of the computer device. Further in the method, receiving the notation element from the user of the computer device may further comprise receiving the notation element from one of: the display of the computer device and the external input device.

In some embodiments, the method further includes the acts of receiving the input from the display of the computer device, relating the input to an area of the display, and associating the notation element with the area of the display.

In other embodiments, the method may further include the acts of storing, on the storage medium, a plurality of notation elements in association with a plurality of references to the related portion of the multimedia event. In addition, the method may further comprise the act of displaying, as a list, the plurality of notation elements in association with the plurality of references on the display of the computer device. Further, the method may comprise exporting the plurality of notation elements in association with the plurality of references from the computer device. In addition, the method may further include transmitting the plurality of notation elements in association with the plurality of references from the computer device to another computer device.

According to another embodiment, a computer-readable medium is disclosed comprising computer-executable instructions that, when executed on a processor of a server, perform a method for associating notations with multimedia elements. The method comprises the acts of displaying a multimedia element on a display of a computer device, receiving a notation element from a user of the computer device, determining, by a processor, at the time of receiving the notation element, a related portion of the multimedia element, and storing, on a storage medium, the notation element in association with a reference to the related portion of the multimedia event.

According to another embodiment, a multimedia notation system is disclosed. The system comprises a multimedia interface configured to display a multimedia element, a user interface configured to receive a notation element from a user of the user interface, an associating element configured to determine a notation time at which the notation element is received, and further configured to identify a portion of the multimedia element related to the notation time, and a storage element configured to store the notation element in association with a reference to the notation time.

In one embodiment, the user interface may be configured to receive an input from one of: a touch-sensitive display, and an external input device, and to determine a control command associated with the input. In the system, the user interface may be configured to receive the notation element from one of: a touch-sensitive display and an external input device. In addition, the user interface may be further configured to receive a gesture input from the user input on the touch-sensitive display. In another embodiment, the user interface may be configured to receive the input from the touch-sensitive display, and the association element is further configured to relate the input to an area of the touch-sensitive display, and associate the notation element with the area of the touch-sensitive display.

According to one embodiment, the storage element is further configured to store a plurality of notation elements in association with a plurality of references to the notation time. In addition, the multimedia interface may be further configured to display, as a list, the plurality of notation elements in association with the plurality of references to the notation time. In one embodiment, the system further comprises a communication interface configured to transmit the plurality of notation elements in association with the plurality of references from the multimedia notation system.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Further features and advantages as well as the structure and operation of various embodiments are described in detail below with reference to the accompanying drawings. In the drawings, like reference numerals indicate like or functionally similar elements. Additionally, the left-most one or two digits of a reference numeral identifies the drawing in which the reference numeral first appears.

FIG. 1 is a landscape or horizontal view of one embodiment of a multimedia element being presented on the viewable screen of a handheld mobile device;

FIG. 2 is a landscape or horizontal view of one embodiment of a multimedia element being presented on the viewable screen of a handheld mobile device with a possible version of a user notation input interface present;

FIG. 3 is a landscape or horizontal view of one embodiment of a multimedia element being presented on the viewable screen of a handheld mobile device containing a built-in keyboard, with a possible version of a user notation input interface present;

FIG. 4 is a portrait or vertical view of one embodiment of a multimedia element being presented on the viewable screen of a handheld mobile device;

FIG. 5 is a portrait or vertical view of one embodiment of a multimedia element being presented on the viewable screen of a handheld mobile device with a possible version of a user notation input interface present;

FIG. 6 is a view of one embodiment of a multimedia element being presented on the viewable screen of a tablet computer with a possible version of a user notation input interface present; and

FIG. 7 is a view of one embodiment comprising both a multimedia element and a user notation input interface being presented on the viewable screen of a computer.

### DETAILED DESCRIPTION

As described above, conventional systems of mobile film editing are inconvenient to use, necessitating multiple discrete interfaces which provide no exchange of information or capacity to communicate between each other. Accordingly, there is a need to create systems and methods that integrate the processes of controlling the playback of multimedia with the process of recording notes. The system and methods operate interactively in a simultaneous and efficient way and may further allow for seamless integration and communication of recorded notes. For example, the entered and stored notes can be sent directly from the system in various flexible formats to another user (e.g. an editor). The system and method may provide further additional security features, such as password-protected downloads, allowing for secure storage and sharing of multimedia from the viewing device.

Aspects disclosed herein, which are in accordance with various embodiments, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to, performing one or more advertising auction functions. However, such a system may also perform other functions. Moreover, the systems described herein may be configured to include or exclude any of the functions discussed herein. Thus the embodiments of the present invention are not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

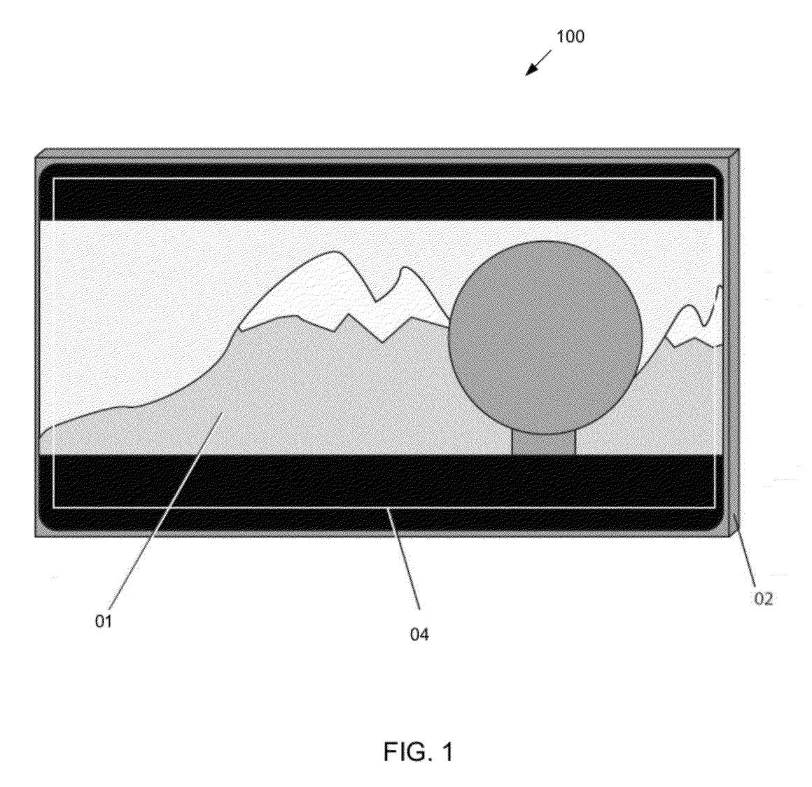

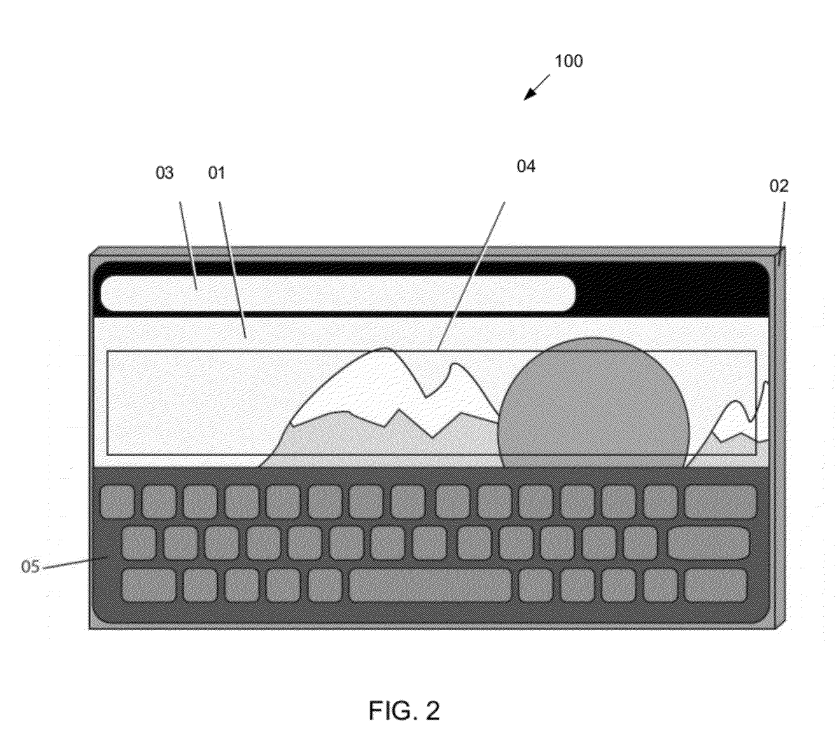

Referring to FIGS. 1 and 2, a system 100 of integrated playback control of multimedia and recording notes on a computer device 02 is shown, in accordance with one embodiment. The computer device 02 includes an interface that provides playback of multimedia 01 and integration of notes during playback. In one example, the computer device 02 is a mobile device and includes a touch-sensitive display. The interface may include a notation entry field 03, a transparent control interface 04, and a virtual keyboard 05 displayed on the display screen of the computer device 02.

FIG. 1 shows one example of the playback of multimedia 01 on the touch-sensitive display of the computer device 02. As shown, the playback of the multimedia 01 extends partially over the display and the display includes an area outside of the multimedia 01 playback (e.g. shown in black) on the edges of the display. However, it is appreciated that the multimedia 01 may extend over any part of the display, for example, based on the settings of the multimedia 01 and the display of the computer device. In this example, the playback of the multimedia 01 continues uninterrupted because no input is received from the user.

FIG. 2 shows another example of the playback of multimedia 01 on the touch-sensitive display of the computer device 02, including the virtual keyboard 05 and the notation entry field 03 displayed on visual display of the device 02. In one example, the virtual keyboard 05 and the notation entry field 03 are displayed in response to receiving the interaction or input from the user via the transparent control interface 04. In other examples, the virtual keyboard 05 and the notation entry field 03 may be displayed in response to receiving predetermined commands from an external input device connected to the device 02, as further described below.

In this example, the virtual keyboard 05 is a visual representation of a physical keyboard displayed on the display of the computer device 02. As shown in the example of FIG. 2, the virtual keyboard 05 and the notation entry field 03 are displayed on a portion of the display covering (or on top of) a portion of the multimedia 01. In other examples, the virtual keyboard 05 and the notation entry field 03 may be displayed side-by-side with the multimedia 01. In this example, the display ratio of the multimedia 01 may change to display the virtual keyboard 05 and the notation entry field 03.

In one example, the user can input notations using virtual keyboard 05 and/or the external input device, which are received by the system and transcribed into the notation entry field 03. Upon completion of a notation, a user can submit the notation, paired with multimedia time code information retrieved from multimedia 01, as further described below. In response to the user submitting the notation, the system 100 can store the notation and the associated time code information into a storage medium. The notations can be stored in association with a particular multimedia 01 in a screening session. The stored notation can then be recalled at a later time by assessing the screening session or by separately accessing the notations. As further described below, the notations, along with the associated time codes, can be compiled from a screening session into a notation file and communicated to another user.

According to one example, the system can control the playback of multimedia 01 on the visual display of device 02 by detecting gestures and actions from a user. Such gestures and actions may be received through the touch sensitive surface of device 02 and interpreted by transparent control interface 04. In one example, the user may also initiate the display and use of virtual keyboard 05, notation entry field 03, multimedia time code monitoring and other provided resources via the use of predefined gestures and actions interpreted by transparent control interface 04 as received through the touch sensitive surface of device 02.

In one embodiment, the transparent control interface 04 monitors for an interaction or input from the user. The interaction can be received through the touch-sensitive surface of the display or the external input device. Examples of an input or interactions may include a single or double tap in one or more areas of the touch sensitive display displaying the multimedia 01, or a single or double tap in one or more areas of the touch-sensitive display outside of the multimedia 01 display area. As used in the examples described herein, a tap includes a touch by the user (e.g. with a finger or a stylus) applying a small amount of pressure to the touch-sensitive display, and instantaneously (e.g. less than 1 second) removing the pressure.

Further examples of the input or interactions may include a swipe in one direction over one or more areas of the touch-sensitive display displaying the multimedia 01, or a swipe in one direction over one or more areas of the touch-sensitive display outside of the multimedia 01 display area. As used in the examples described herein, a swipe includes a touch and drag by the user (e.g. with a finger or a stylus), applying a small amount of pressure to the touch-sensitive display over a distance on the display, and then removing the pressure. The length or time and the distance of the swipe may be based on associated the action the swiping gesture. For example, for if the swipe is associated with a fast forward function, the user may vary the length of time and the distance of the swipe based on the amount of time the user wants to fast forward.

Additional examples of the input or interactions may include a three finger swipe left and right in the touch-sensitive display. Other examples can include multiple finger taps or two-finger swipes in any direction. Circular input motions may also be received by the display. One example may include inputting circular motions as controlling a virtual jog wheel—spinning the jog wheel clockwise or counterclockwise. It is appreciated that the system is not limited to the particular inputs and/or interactions described herein, and any inputs and/or interaction currently known or later developed may be used, as would be understood by those skilled in the art, given the benefit of this disclosure.

Other methods of input or interaction may be provided, for example, interactions that are associated with different portions of the display of the computer device. In one example, the touch sensitive display may determine the exact location of the user interaction or input on the touch sensitive display, for example, the location or a tap or a swipe. This functionality may allow users to draw on certain parts of the display to visually annotate certain sections of the multimedia frame. For example, the recorded tap or swipe may be visually indicated as a point, a line, a square or circle or any other geometric figure. The visual annotation can be stored and recalled in the notes list, described below. In one example, each note display in the note list may include an image of visual annotation and a screenshot of the corresponding portion of multimedia. In some examples, the visual annotation may be displayed over the multimedia during playback.

In response to receiving input in the form of gestures or other input, the transparent control interface 04 can take any number of pre-determined actions or controls. For example, the actions or controls can include, but are not limited to, initiating a note, extracting a time code from the displayed multi media, showing predetermined playback controls, controlling playback of the media directly without accessing playback controls, submitting a completed note, or completing a note entry by pairing user-inputted text with time code and storing these elements on the storage medium. It is appreciated that the system is not limited to the particular actions described herein, and any actions currently known or later developed may be used, as would be understood by those skilled in the art, given the benefit of this disclosure.

According to some embodiments, input or interaction received by the transparent control interface 04 may be mapped to particular actions. In at least one embodiment, the user may change the input or interaction to match different actions. In one example, a tap in the center of touch-sensitive display screen inside of the multimedia 01 display area, may initiate a note (e.g. display the note taking interface 03). However, in another example, the user may change the setting to have the tap in the center pause playback of multimedia 01.

The inputs and the mapped actions may be different based on the interface and the user interaction. In one example, a tap in the center of the display may be associated with an action to submit a note to be saved once a note is in the process of being created. In another example, the tap in the center of the display can cancel a note if the note entry field is left blank. Other examples of mapped inputs to functions can include a tap on the edges of the display outside of the playback area mapped to show/hide playback controls. In one example, a double tap in center of display during playback may play or pause video playback. In another example, a double tap on the edges of the display outside of the playback area may be mapped to predefined system playback features if available for example, zoom video to fill screen. In other examples, a swipe left over the multimedia playback part of the display may be matched to rewinding the multimedia (e.g., for a predefined number of seconds set by user in settings).

According to other examples where input is received from an external input device, the input is similarly received by the system, interpreted and the associated or mapped control or action is determined The input or indications can be customizable by the user. In one example, custom or selectable keyboards with quick keys may be provided for making frequently typed notes (such as “raise music level”). Various custom keyboards could be selected by user in settings, turned on and/or off completely, or loaded depending on the type of gesture made by the user. However, it is appreciated that the system is not limited to the particular mapping of inputs and action described herein. As a result, any input can be matched to any action currently known or later developed, as would be understood by those skilled in the art, given the benefit of this disclosure.

According to various embodiments, time codes are associated with the notes described above may be extracted from the multimedia 01. In these embodiments, the multimedia may include metadata which specifies a playback time associated with frames within the multimedia 01. The system 100 may extract the time code metadata information from the multimedia file on-demand, for example, when a note is entered by the user. According to other embodiments, the time code information may not be available because the multimedia format does not provide time code information or because the time code information may not be easily extractable. In these examples, the time code information is determined by the system 100. However, the system 100 is not limited to the determination of time codes as described herein, and methods of determining time codes currently known or later developed may be used, as would be understood by those skilled in the art, given the benefit of this disclosure.

One example of determining time codes includes a zero-based elapsed time counter method. In one example of this method, the system 100 first retrieves the current playback position of the multimedia in fractions of seconds (X), offset from the start of the multimedia, which begins at 0 seconds. The current playback position may be combined with data extracted from the multimedia file that indicates the starting frame offset of the multimedia from the original editing system timeline (Y) and the playback frame rate of the multimedia (Z). The starting frame offset can be typically written into the multimedia file by the editing system creating the multimedia to indicate the actual starting time (frequently not 0). Using X and Z, the system 100 can determine how many frames to add to Y. The result provides the exact frame number location of the current position in the multimedia as it correlates to the same position in time in the original timeline of the multimedia on the editing system where it originated. That frame number can then be translated to hours, minutes, seconds and frames to be displayed as an accurate time code relative to the original edit.

As shown in FIGS. 1 and 2, the system 100 is implemented using a touch-sensitive handheld computer device 02. However it should be appreciated that the input functionality may also be provided via other input methods or devices, for example via an external input device, connected directly or wirelessly to the device 02. One example of an external input device may include, but is not limited to, a keyboard. The external input device may be integrally connected to display screen of the computer device 02, or may be external connected by standard connection methods. In some embodiments, the system 100 may receive input from the touch sensitive device 02, the external input device, or the combination of both the touch-sensitive device 02 and the external input device. In other embodiments, the system may be controlled via an external input device, regardless of whether device 02 provides a touch sensitive interface.

According to various embodiments, multimedia 01 may include graphics, text, animation, video, audio or any combinations thereof and may be implemented using any multimedia platform or format. For example, platforms or formats may include but are not limited to video formats, including QuickTime and MP4, AVI, Advanced Systems Format, MPEG, EVO, the flash platform, including F4V, FLV, or DivX Media Format. In another example, multimedia 01 may be limited to the type of multimedia that the computer device can natively play. In one example, multimedia 01 may be encoded into any format and may include any compression settings. In other examples, a user may first convert the multimedia into a desired format and compression setting prior to importing the multimedia into the system 100. The multimedia may include additional metadata such as the time code metadata described above.

As discussed above the system 100 may provide various user settings. The settings allow the user to personalize or customize various controls. For example, the setting can allow the user to modify rewind functions, pausing functions, optically display time codes, change or manage input mapping functions described above, or set other naming or tagging options described below.

In some examples, the user can customize or set a rewind function. It is appreciated that user's response time (e.g. time it takes for the user to tap the display after seeing a desired stopping point) may be slower than playback of the multimedia. The rewind function may allow the user to correct for slowed response time to perform the desired functions at the appropriate time during playback. For example, the rewind function may compensate for slowed response time associated with the user tapping the display to pause/play, rewind/fast forward. Further, the rewind function may allow the user to more accurately pinpoint the exact frame and associate a more accurate time code with that frame for entering notes.

For example, the user can tap the display to pause during playback to input a note associated with a particular frame. By the time the user's finger touches the display, a later frame is displayed on the display. The system jumps back (or rewinds) the multimedia playback based on the predetermined setting to pause at some predetermined frame before the user tapped the display. The user can customize the rewind function by setting the number of seconds (or frames) that the rewind function can jump back when a input is detected from the user, such as 1, 3, 5, 7 or 10 seconds.

In various examples, the notes entered by the user during playback and stored by the system may be viewed, managed further edited and sent to other users. The notes may be displayed as a list and may further include the time code information associated with the note. The displayed notes may be edited and managed by the user. For example, the user may edit the text of the note or the time code associated with the note. In at least one example, the user can input their name or username into the system, and the name, username, photograph, or avatar can be displayed in association with the notes taken by that user.

In some examples, the user may organize the notes by type by entering “tags.” The system may provide for the user a predefined set of tags, or provide for the user to enter custom tags. Examples of predefined tags may indicate sound, lighting, editing, vfx, music or any other type of association. In some examples, the user may select a note in from the list of notes and the system 100 may display (or jump) to the portion of the multimedia 01 associated with the note based on the time code. In some examples, the specific input or indications may be associated with specific tags. This feature may allow for quick tagging of a note at the time that the note is input, rather than at a later time in the notes list.

In other examples, the system 100 may provide for the user to import notes into a screening session. The user may receive notes associated with time codes from another user and may import them into the system. The system 100 may display the notes as a list in the note management screen and may further display the individual notes during playback. In some examples, while the user is viewing the playback of multimedia 01, the system may provide an indication of an existence of a note associated with the time code. For example, the system may flash a visual indication (e.g. an icon) in a portion of the screen. In other examples, the note text may be displayed briefly over the playback of the multimedia.

According to various examples, the stored notations or session notes may be sent to other users or filmmakers. In some examples, the stored notations may be converted to a particular file type prior to sending. The user may select the particular file type to convert the files. For example, the file types may include, but are not limited to spreadsheet files, XML files, text file types or any other file types. In one example, the notations may be embedded into a body of an email to be sent to other users or filmmakers. In some examples, the session notes may be exported and sent using a file type that is unique to the system 100. This file type may be imported into the integrated system of another user along with the multimedia, allowing the other user to view the notations within the multimedia on their device.

According to one embodiment, in addition to the system 100, a central service for collaborating on multimedia and sharing of notes may be provided. In one example, the central service includes a central database, a user interface, and a communication interface. The central service may be implemented as a cloud-based computing platform, such as the EC2 platform, available from Amazon.com, Seattle, Wash. However, it should be appreciated that other platforms and cloud-based computing services may be used.

The communication interface can serve as an interface between the central service and the individual computer devices and further facilitate their interaction. The central database may store the multimedia from multiple users and/or devices, the notations input by the various users, and the time codes associated with the notations. The central database may also store additional information such as user information, for example, user identification, any associated comments, notations, and/or screening sessions, as well as any other relevant user information.

The user interface may provide for different users to collaborate on multimedia and share and export notes. The user may access any multimedia file or notations from other users that the user has permission to access. In various examples, the multimedia file may be stored on the central service. In some examples, the user may view the multimedia on the central service and input notations in the user interface of the central service. In other examples, the central service may provide for the user to either stream the multimedia from the central service or to download the multimedia file from the central service. In these examples, the user may input notations on the computer device.

The multimedia file may include the notations from the owner of the multimedia file and any notations from other contributors to the multimedia. In one example, the notations are displayed simultaneously in a list adjacent to the multimedia during playback or in a separate list apart from multimedia playback. In another example, the notations may be superimposed over the multimedia during playback. The user may further export from the central server any and all notations to which the user has access.

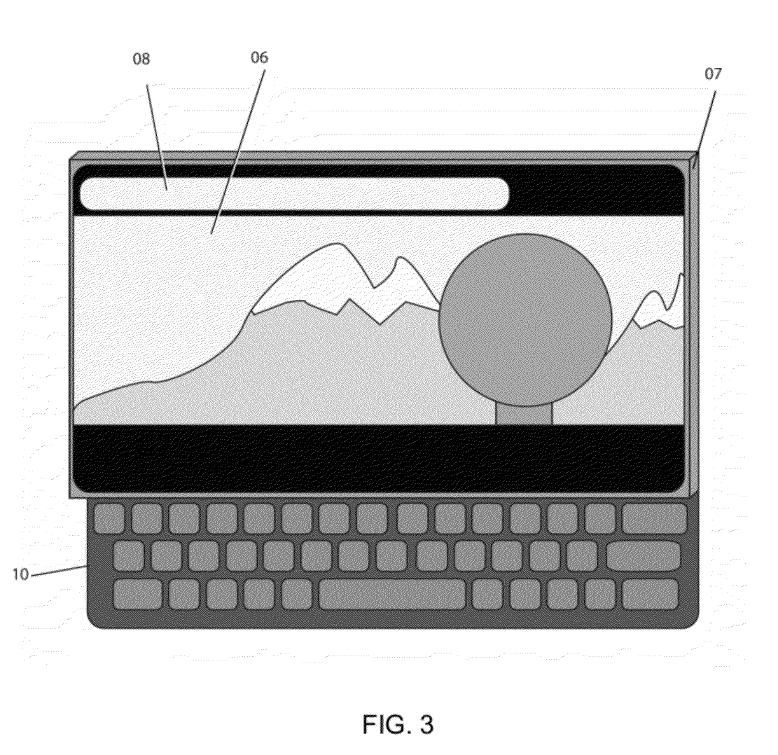

According to some embodiments, the system 100 may be implemented on any computer device including a cell phone, a smart phone, a tablet computer, a laptop computer, a desktop computer or another suitable computer system. Referring now to FIG. 3, another embodiment of system 100 is shown as it is implemented on a computer device 07 that contains an attached user interface keyboard 10. In one example, the computer device 07 is a mobile device and may include an optional touch sensitive interface.

Referring still to FIG. 3, the system 100 can control the playback of multimedia 06 presented on the visual display of device 07 via input from a user through attached keyboard 10, or through an external input device if available. A user can input notations using attached keyboard 10 and/or an external input device, which will be transcribed as per this input from the user into notation entry field 08. Upon completion of a notation, a user can submit the notation, paired with multimedia time code information retrieved from multimedia 06 should a user choose it to be included, at which point the notation can be stored and recalled at a later time.

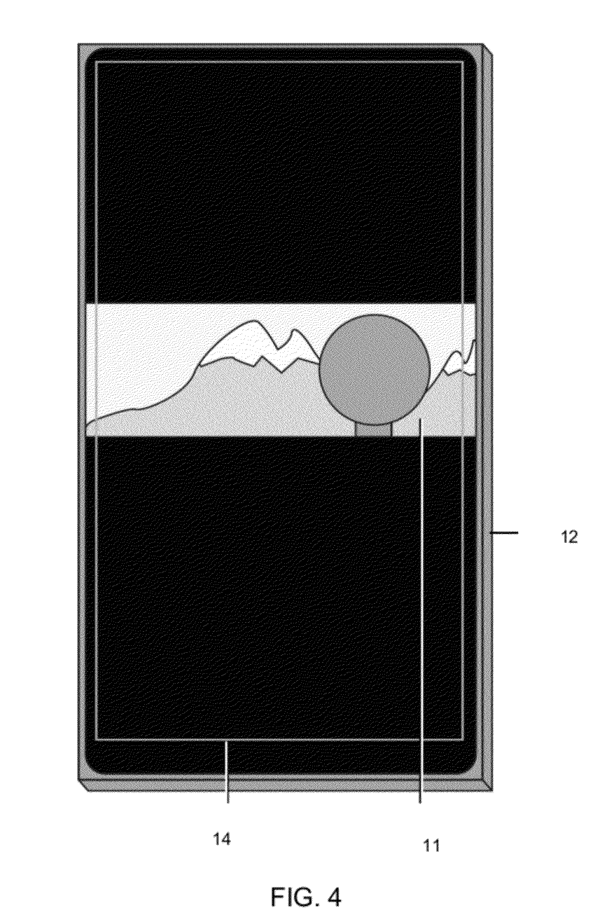

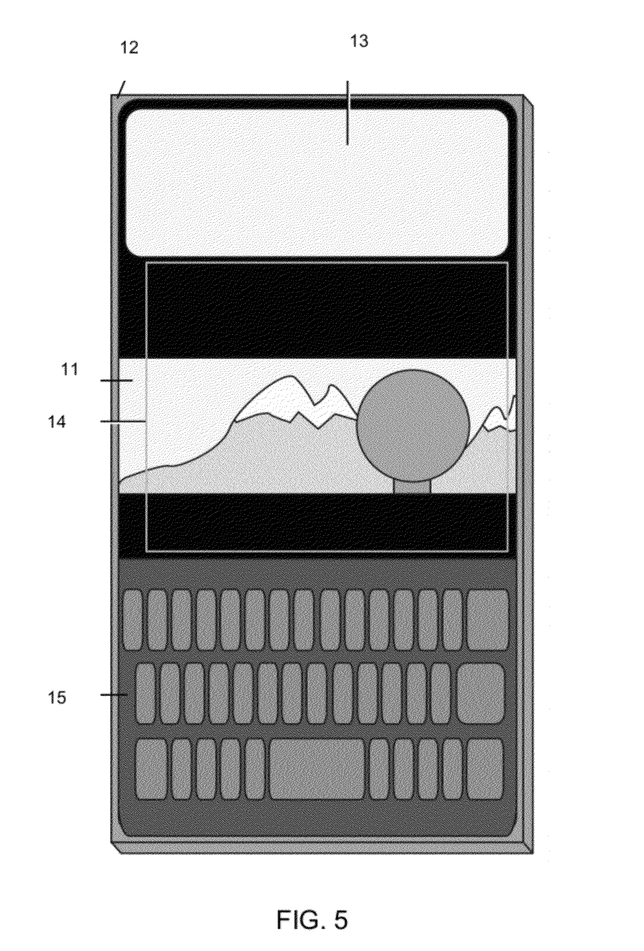

Referring now to FIGS. 4 and 5, another embodiment of system 100 is shown as it is implemented on a computer device 12. In on example, the computer device 12 is a touch sensitive handheld mobile device. The computer device 12 is similar to the computer device 02 shown in FIG. 1 but with a different orientation. A touch sensitive device is not required however, as the system may be operated via an external input device. Some embodiments may rely on either a touch sensitive device, additional external input device, or the combination of both. In some embodiments, playback of multimedia 11 presented on the visual display of computer device 12 may be controlled with a transparent control interface 14 that detects user gestures and actions. FIG. 5 further displays how a virtual keyboard 15 and notation entry field 13 may be displayed on device 12 in response to the appropriate commands received from the user via control area 14 or another external input device connected to device 12.

Referring still to FIGS. 4 and 5, the system 100 can control the playback of multimedia 11 presented on the visual display of device 12 via gestures and actions from a user interpreted by transparent control interface 14 as received through the touch sensitive surface of device 12, as described above. In some embodiments the system 100 may be controlled via an external input device, regardless of whether device 12 provides a touch sensitive interface. The user may also initiate the display and use of virtual keyboard 15, notation entry field 13, multimedia time code monitoring and other provided resources via the use of predefined gestures and actions interpreted by transparent control interface 14 as received through the touch sensitive surface of device 12, or through an optional external input device. The user can input notations using virtual keyboard 15 and/or an external input device, which will be transcribed as per this input from the user into notation entry field 13. Upon completion of a notation, the user can submit the notation, paired with multimedia time code information retrieved from multimedia 11 should the user choose it to be included, at which point the notation can be stored and recalled at a later time.

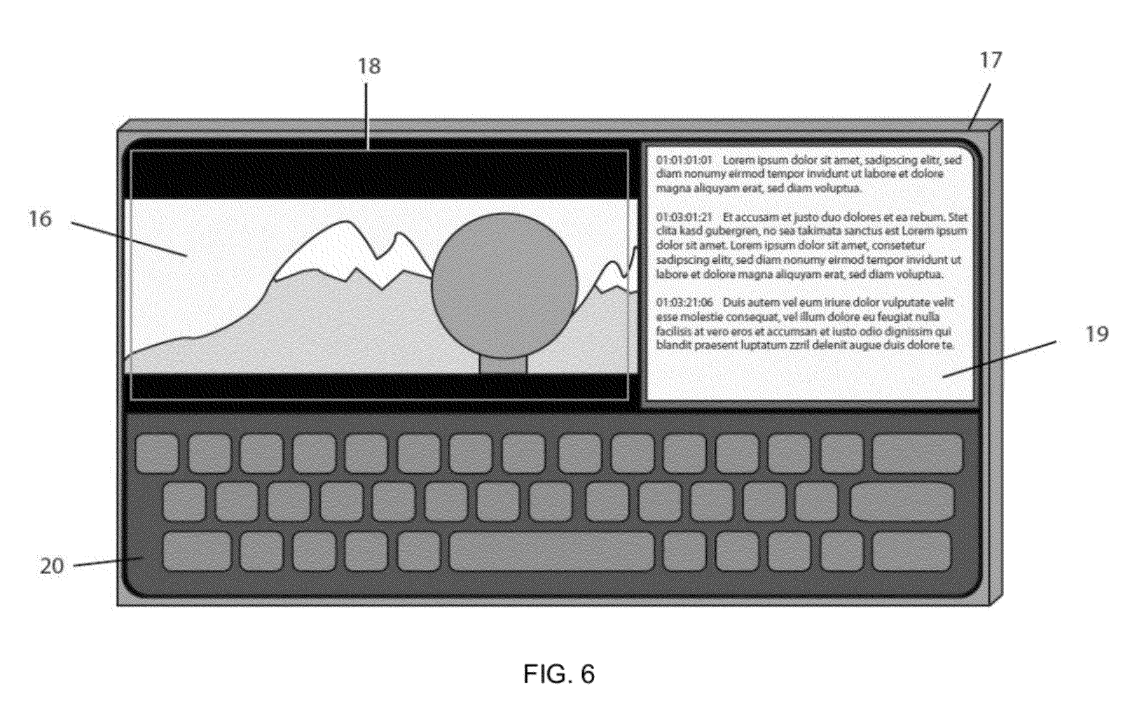

Referring now to FIG. 6, an embodiment of the system 100 implemented on a computer device 17 is shown. In one example, the computer device 17 includes a touch sensitive mobile device with a large display, such as a tablet computer. For example, the large display may include a display larger in compassion with the computer device 02 shown in FIG. 1. The user may either use the touch sensitive display of the computer device 17, or alternatively, the user may input notation and control the system via an external input device. The system may incorporate a touch sensitive device, additional external input device, or the combination of both. FIG. 6 shows the playback of multimedia 16 presented on the visual display of computer device 17, and visually shows a transparent control interface 18 that detects user gestures and actions.

In one embodiment, a text area 19 and a virtual keyboard 20 are displayed adjacent to the playback of the multimedia over a portion of the display. In this embodiment, the display ratio of the multimedia is scaled to fit the designated portion of the display. The text area 19 and a virtual keyboard 20 may be displayed a result of detecting gestures and actions from a user interpreted by transparent control interface 18.

The system 100 may provide for control of playback of multimedia 16 presented on the visual display of device 17 via gestures and actions from a user interpreted by transparent control interface 18 as received through the touch sensitive surface of device 17. The system 100 can command and control the playback of multimedia 16 displayed on device 17 based on input received from an external input device, regardless of whether device 17 provides a touch sensitive interface. A user may also initiate multimedia time code monitoring and other provided resources via the use of predefined gestures and actions interpreted by transparent control interface 18 as received through the touch sensitive surface of device 17 or through an external input device which may be, but is not required to be, available.

The user can input notations using virtual keyboard 20 and/or an external input device, which are then input into the text area 19 and paired with multimedia time code information retrieved from multimedia 16. The user can submit the notation to be stored, and the system can store the notation to be recalled at a later time. In this embodiment, the currently recorded notation is displayed in the text area 19 with other previously stored notations. The user can view a list of notations displayed by the system along with the associated time codes as shown in FIG. 6. In one example, the text area 19 along with the notations may be visible and displayed by the system during playback of multimedia 01. In other embodiments, the text area 19 may not be displayed during playback and may only be displayed as a result of detected gestures or action.

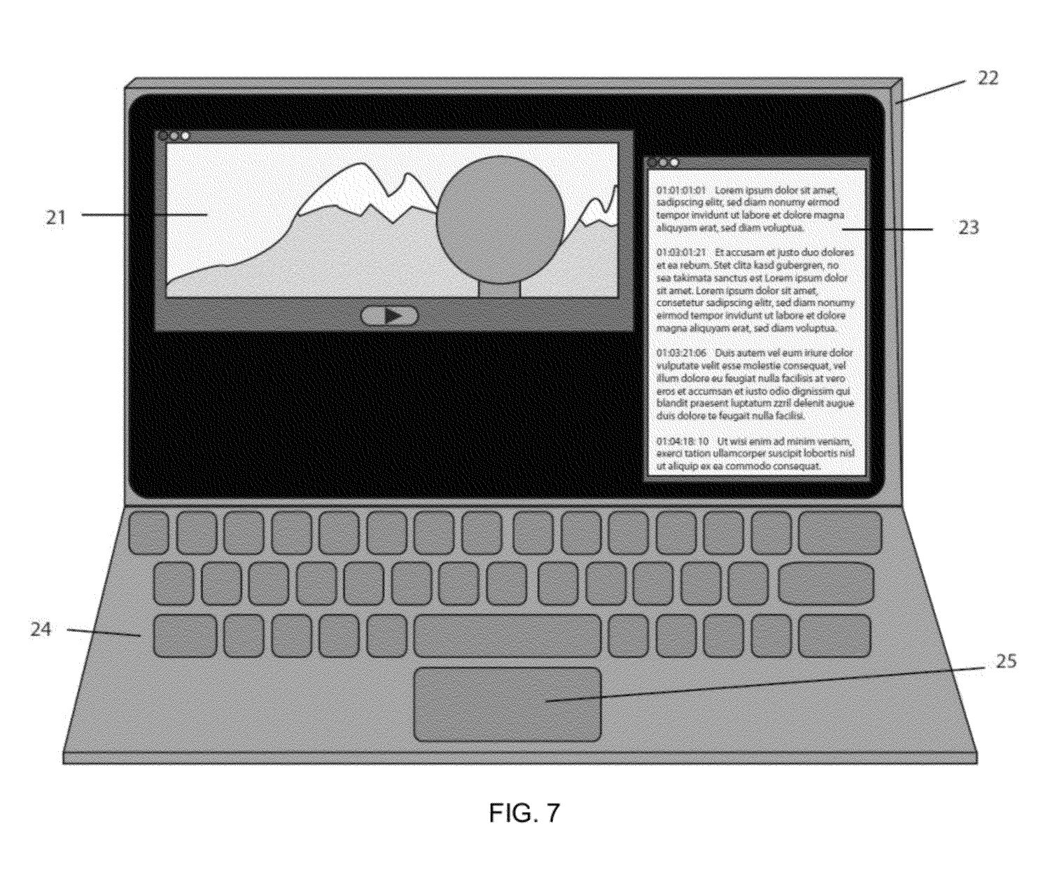

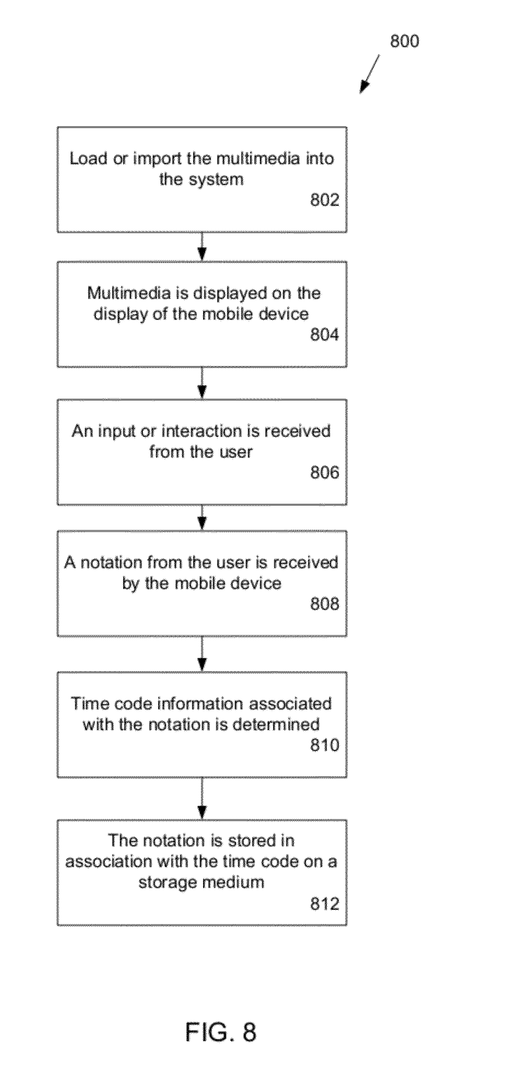

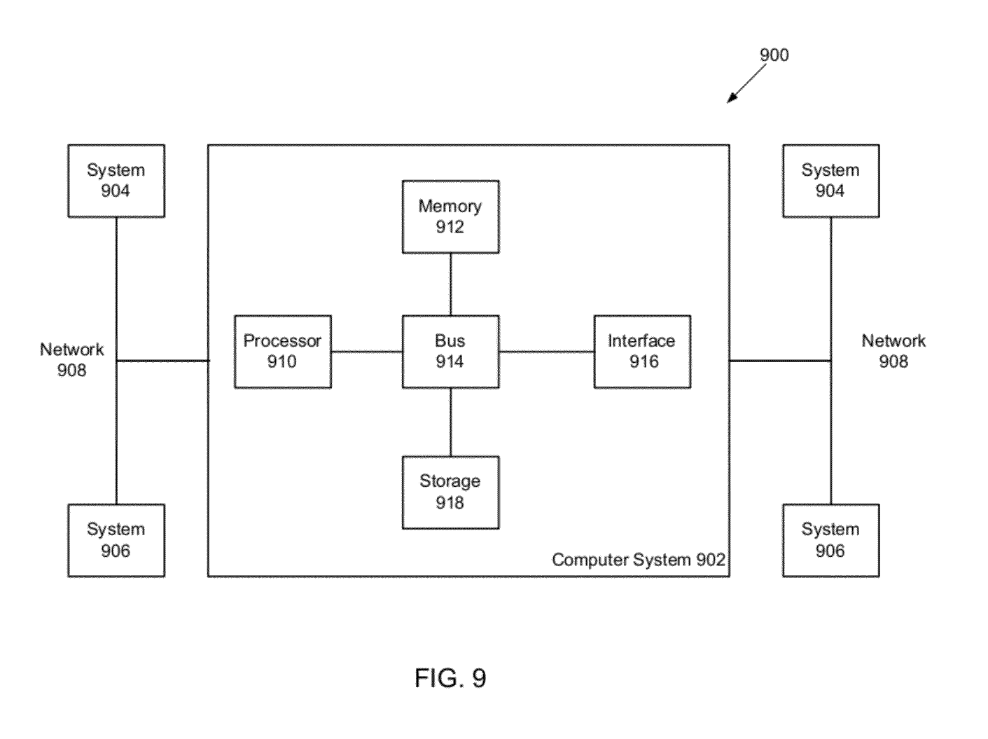

FIG. 7 shows another embodiment of the system 100 as it is implemented on a computer device 22. As shown, the computer device 22 includes a computer laptop, however it is appreciated that the computer device 22 may include a desktop computer or any suitable computer system. FIG. 7 shows the system 100 controlling playback of multimedia 21 presented on the visual display of computer 22, a text area 23 displayed on the visual display of the computer 22, and user interface devices including a keyboard 24 and a pointing device 25.

Referring still in FIG. 7, the system 100 can control playback of multimedia 21 presented on the visual display of computer 22 via input from a user through keyboard 24 and/or pointing device 25, either attached to computer 22 or connected wirelessly as an external input device. The user can input notations using keyboard 24 and/or an external input device. The input notations are received by the system from the user and are paired with multimedia time code information retrieved from multimedia 21. The notations along with the time code information can be stored and recalled at a later time. The notations along with the time codes can be displayed in the text area 23 with other previously stored notations.

Referring to FIGS. 1 through 7, an embodiment is shown as a possible suggestion of the implementation of the system on one of many target devices. As the system may be intended to be distributed for use on a multitude of devices, the size and design of all elements of the interface may be such that the functionality of the system is accessible relative to the design of each device that may host the system. The system may be scalable so that the interface design may be adjusted by a user to facilitate functionality. The interface design may vary for each host device as to accommodate as similar as possible operation to that described herein, as allowed by the manufacturing of each host device, or may be scalable so that the interface design may be adjusted by a user to facilitate functionality.

FIG. 8 shows one example of a method 800 for integrated playback control of multimedia and notation recording for example by using the computer devices and distributed communication systems described above with reference to FIGS. 1-7 and the computer systems described below with reference to FIG. 9.

In step 802, the user may first load or import the multimedia into the system. The multimedia may be imported into the system from a number of sources, for example, from the memory of the computer device by specifying the file location of the multimedia file, from the Internet website by inputting a URL address of the multimedia, from remote file sharing and storage applications, and/or from Internet website that include progressive steaming multimedia. The multimedia files may be password protected and the system provides for the user to enter login and password information. In one embodiment, once the multimedia is imported into the system it is stored locally in member of the device and can be viewed and edited at any time.

In one example, the computer device and the system may automatically receive multimedia from one or more sources. For example, the computer device may be synced with a particular Internet address having multimedia content. As the user starts up the system, the computer device may automatically receive any new multimedia file from the Internet location. Similarly, the computer device may be synced to another computer device and may automatically receive any new multimedia file from another device. This syncing feature may allow for multiple users to take notes on different devices simultaneously, all synced together.

In one embodiment of the syncing feature, the multiple devices can be set up as a master and slave devices. For example, one device (e.g. the master device) may be playing the video and distributing time code information to one or more of the slave devices. In some examples, the slave devices may input and store notes locally on the device. In other examples, the slave device may transmit the notes back to the Master device, which receives and stores the notes from the slave devices.

According to one embodiment, for each multimedia filed stored on the device, the system may generate, per user input, one or more screening sessions. Each screening session includes the notes entered by the user during playback and stored on the system. In one example, one or more users may create multiple screening sessions for one multimedia file. Or the user may create multiple different screening sessions, for example to include notes to different aspects of the multimedia. The system may provide for the user to enter a name for each screening session. Alternatively, the system may automatically generate a name for the session.

In at least one embodiment, for each screening session the system may provide an input for the user to access a notes screen. The note screen may display a list of notes created by the user and stored by the system. In this screen the user may edit notes that have already been created, or add new notes by entering time code information and note information. In an embodiment, the user may access the playback of the multimedia, without entering the note screen.

In step 804, the user selects the playback feature and the system displays the multimedia on the display of the computer device. As discussed above, the multimedia may be displayed on a portion of the display or on the entire display based on the type of computer device and the settings of the multimedia and/or setting of the device.

In step 806, the system receives an input or interaction from the user. In one example, the transparent control interface monitors for the input and once the input is received, the transparent control interface interprets the input. In another example, the input may be received from a virtual keyboard displayed on the display of the computer device or a physical keyboard included in the computer device. In yet another example, the input may be received from an external input device described above. The input may be interpreted by the transparent control interface and matched with predetermined actions or controls. In other examples, the input received from the virtual or physical keyboard or an external input device may be matched by the system with predetermined actions or controls.

For example, the input may include a single tap on the touch sensitive display of the computer device, which is interpreted by the transparent control interface and matched with a pause function or control. In this example, the playback is paused and the system displays a note input field and the virtual keyboard. Any other functions or controls may be performed as a result of receiving the input, some of which are described above.

In step 808, the system receives a notation from the user of the computer device. In one example, the user enters the notation in the notation field. The notation may include any comment from the user regarding any aspect of the multimedia, for example “shot holds too long—cut out earlier.” In some examples, the notation received from the user may be an intentionally blank notation. In these examples, the blank notations allow the user to quickly mark and store various time codes in the multimedia. The user may then later access and edit the blank time codes.

In step 810, the system determines time code information associated with the notation. According to one embodiment, time code information includes a related portion of the multimedia element, recorded at the time of receiving the notation element. In one example, the time code may be extracted from the multimedia using the methods described above. In another example, the time code may be determined using zero based elapsed time counter method described above. However, any method of determining time codes currently known or later developed may be used, as would be understood by those skilled in the art, given the benefit of this disclosure.

In step 812, the system stores, on a storage medium, the notation in association with the time code. In one example, the notations may be stored in response to receiving a submit command from the user. For example, the user may tap the display once the note is entered, click submit button, or the enter key on the virtual keyboard. As described above, according to various examples, the stored notations may be sent to other users or filmmakers.

An advantage of the present system and method is that they provide a consolidated method for combining and controlling the resources of multimedia playback of video and/or audio, video and/or audio timing references, and notation recording. They provide a framework for efficiently sharing data between each resource, while providing control over a number of resources simultaneously. They yield a process of operation of these resources that saves time while more accurately creating notations relative to video and/or audio multimedia.

In broad embodiment, a system and method are provided for integrating the processes of and resources for controlling multimedia playback with the process of recording notation along with timing information relative to the multimedia being presented, while allowing these processes and resources to communicate data generated or retrieved by each to the other if such communication is desired by a user.

Examples of Computer Systems

Various aspects and functions of the systems and services describe above with respect to FIGS. 1-8 may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Further, aspects may be located on a single computer system or may be distributed among a plurality of computer systems connected to one or more communications networks.

Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 9, there is illustrated a block diagram of a distributed computer system 900, in which various aspects and functions may be practiced. The distributed computer system 900 may include one more computer systems that exchange (i.e. send or receive) information. For example, as illustrated, the distributed computer system 900 includes computer systems 902, 904 and 906. The distributed computer systems may be one or more computer devices such as the computer devices 02, 07, 12, 17, or 22 shown in FIGS. 1-7.

As shown, the computer systems 902, 904 and 906 are interconnected by, and may exchange data through, a communication network 908. The network 908 may include any communication network through which computer systems may exchange data. To exchange data using the network 908, the computer systems 902, 904 and 906 and the network 908 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. The computer systems may also communicate through a cellular radio network access such as Global System for Mobil communication (GSM), General Packet Radio Services (GPRS), Enhanced Data GSM Environment (EDGE), Wideband Code Division Multiple Access (WCDMA), among other communication standards. The network may further employ a plurality of cellular access technologies including 2nd (2G), 3rd (3G), 4th (4G or LTE) generation radio access for cellular systems, WLAN, Wireless Router (WR) mesh, and the like. Access technologies such as 2G, 3G, 4G and LTE and future access networks may enable wide area coverage for mobile devices. In essence, network may include any communication mechanism by which information may travel between the devices and another computing device in the network.

Communications within the network, including any messages, requests and inquires can be transmitted or formatted to any format acceptable by the target system, such as, HTML and plain text emails, SMS messages, MMS messages, IM messages, audio messages, VOIP messages, plain text messages, any propriety format, among other communication standard.

The computer system 902 may also include a processor 910 which may comprise one or more microprocessors or other types of controllers, can perform a series of instructions that result in manipulated data. The processor 910 may be a commercially available processor such as Apple/Samsung Apple A4, A5 and A5X, ARM Cortex, Qualcomm Krait, and Snapdragon, an Intel Medfield, Xeon, Itanium, Core, Celeron, Pentium, AMD Opteron, Sun UltraSPARC, IBM Power5+, or IBM mainframe chip, but may be any type of processor, multiprocessor or controller. As shown, the processor 910 may be connected to other system elements, including the memory and the touch sensitive display of the computer device.

The memory 912 may be used for storing programs and data during operation of the computer system 902. Thus, the memory 912 may be a relatively high performance, volatile, random access memory such as a dynamic random access memory (DRAM) or static memory (SRAM). However, the memory 912 may include any device for storing data, such as a disk drive or other non-volatile storage device. Various examples may organize the memory 912 into particularized and, in some cases, unique structures to perform the functions disclosed herein and these data structures may be tailored to store values for particular types of data.

Components of the computer system 902 may be coupled by an interconnection element such as the bus 914. The bus 914 may include one or more physical busses, for example, busses between components that are integrated within a same machine, but may include any communication coupling between system elements including specialized or standard computing bus technologies such as IDE, SCSI, PCI and InfiniBand. Thus, the bus 914 enables communications, such as data and instructions, to be exchanged between system components of the computer system 902.

The computer system 902 also includes one or more interface devices 916 such as input devices, output devices and combination input/output devices, such as the external input devices described above. Interface devices may receive input or provide output. More particularly, output devices may render information for external presentation. Input devices may accept information from external sources. Input devices may accept information from external sources. Examples of interface devices include mouse devices, trackballs, microphones, touch screens, printing devices, display screens, speakers, as well as other interface devices.

The data storage 918 (referred to above as memory or storage medium) may include a computer readable and writeable nonvolatile (non-transitory) data storage medium in which instructions are stored that define a program or other object that may be executed by the processor 910. The data storage 918 also may include information that is recorded, on or in, the medium, and this information may be processed by the processor 910 during execution of the program. More specifically, the information may be stored in one or more data structures specifically configured to conserve storage space or increase data exchange performance. The instructions may be persistently stored as encoded signals, and the instructions may cause the processor 910 to perform any of the functions described herein. The medium may, for example, be optical disk, magnetic disk or flash memory, among others. In operation, the processor 910 or some other controller may cause data to be read from the nonvolatile recording medium into another memory, such as the memory 912, that allows for faster access to the information by the processor 910 than does the storage medium included in the data storage 918. The memory may be located in the data storage 918 or in the memory 912, however, the processor 910 may manipulate the data within the memory 912, and then copy the data to the storage medium associated with the data storage 918 after processing is completed. A variety of components may manage data movement between the storage medium and other memory elements and examples are not limited to particular data management components. Further, examples are not limited to a particular memory system or data storage system.

The computer system 902 may include an operating system that manages at least a portion of the hardware elements included in the computer system. A processor or controller, such as the CPU, may execute an operating system which may be, among others, a MAC OS System or iOS mobile operating system available from Apple Computer, a Windows-based operating system (for example, Windows CE (Windows Embedded Compact) Windows XP, Windows Vista, Windows 7 or Windows 8) available from the Microsoft Corporation, one of many Linux-based operating system (for example Android operating system for mobile devices available from Google, or a UNIX operating systems available from various sources. Many other operating systems may be used, and embodiments are not limited to any particular operating system.

The processor 910 and operating system together define a computer platform for which application programs in high-level programming languages may be written. These component applications may be executable, intermediate, bytecode or interpreted code which may communicate over the communication network 908. The application interfaces disclosed herein may be developed using a Software Development kit (SDK) such as iOS SDK, Xcode, Android SDK, Visual Studio, Visual C++, Java EE SDK, GTK+, GNUstep, wx Widgets or any other SDK. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Thus, functional components disclosed herein may include a wide variety of elements, e.g. executable code, data structures or objects, configured to perform the functions described herein.

Although the computer system 902 is shown by way of example as one type of computer system upon which various aspects and functions may be practiced, aspects and functions are not limited to being implemented on the computer system 902 as shown in FIG. 9. Various aspects and functions may be practiced on one or more computers having a different architectures or components than that shown in FIG. 9.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of the invention. Accordingly, the foregoing description and drawings are by way of example only.

What is claimed is:

1. A method for associating notations with multimedia elements, comprising:
providing, a user interface to a user on a display of a computer device, the user interface including an input component configured to receive input from the user and a multimedia display component;
displaying, by the multimedia display component, a multimedia element on the display of the computer device;
receiving, by the input component, a notation element from the user of the computer device;
determining, by a processor, at the time of receiving the notation element, a related portion of the multimedia element; and
storing, on a storage medium, the notation element in association with a reference to the related portion of the multimedia event.

2. The method of claim 1, further comprising
responsive to receiving, by the input component, a control command from the user, changing a playback status of the multimedia element.

3. The method of claim 1, wherein the reference to the related portion of the multimedia event comprises time code information.

4. The method of claim 2, further comprising:
receiving an input from one of: an external input device coupled to the computer device, and the display of the computer device; and
determining, by the processor, the control command associated with the input.

5. The method of claim 4, wherein receiving the input from the display of the computer device comprises receiving a gesture input by the user in the display of the computer device.

6. The method of claim 4, wherein receiving the notation element from the user of the computer device further comprises receiving the notation element from one of: the display of the computer device and the external input device.

7. The method of claim 1, further comprising:
receiving the input from the display of the computer device;
relating the input to an area of the display; and
associating the notation element with the area of the display.

8. The method of claim 1, further comprising storing, on the storage medium, a plurality of notation elements in association with a plurality of references to the related portion of the multimedia event.

9. The method of claim 8, further comprising displaying, as a list, the plurality of notation elements in association with the plurality of references on the display of the computer device.

10. The method of claim 8, further comprising exporting the plurality of notation elements in association with the plurality of references from the computer device.

11. The method of claim 8, further comprising transmitting the plurality of notation elements in association with the plurality of references from the computer device to another computer device.

12. A computer-readable medium comprising computer-executable instructions that, when executed on a processor of a server, perform a method for associating notations with multimedia elements, comprising acts of:
displaying a multimedia element on a display of a computer device;
receiving a notation element from a user of the computer device;
determining, by a processor, at the time of receiving the notation element, a related portion of the multimedia element; and
storing, on a storage medium, the notation element in association with a reference to the related portion of the multimedia event.

13. A multimedia notation system comprising:
a multimedia interface configured to display a multimedia element;
a user interface configured to receive a notation element from a user of the user interface;
an associating element configured to determine a notation time at which the notation element is received, and further configured to identify a portion of the multimedia element related to the notation time; and
a storage element configured to store the notation element in association with a reference to the notation time.

14. The multimedia notation system of claim 13, wherein the user interface is configured to receive an input from one of: a touch-sensitive display, and an external input device, and to determine a control command associated with the input.

15. The multimedia notation system of claim 13, wherein the user interface is configured to receive the notation element from one of: a touch-sensitive display and an external input device.

16. The multimedia notation system of claim 14, wherein the user interface is configured to receive a gesture input from the user input on the touch-sensitive display.

17. The multimedia notation system of claim 14, wherein the user interface is configured to receive the input from the touch-sensitive display, and the association element is further configured to:
relate the input to an area of the touch-sensitive display; and
associate the notation element with the area of the touch-sensitive display.

18. The multimedia notation system of claim 13, wherein the storage element is further configured to store a plurality of notation elements in association with a plurality of references to the notation time.

19. The multimedia notation system of claim 18, wherein the multimedia interface is further configured to display, as a list, the plurality of notation elements in association with the plurality of references to the notation time.

20. The multimedia notation system of claim 18, further comprising a communication interface configured to transmit the plurality of notation elements in association with the plurality of references from the multimedia notation system.
